(19) United States
(12) Patent Application Publication
(10) Pub. No.: US 2006/0258820 A1
(43) Pub. Date: Nov. 16, 2006

(54) Process for preparing dispersions of crosslinked organopolysiloxanes

(75) Inventor: Otto Schneider, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/430,371

(22) Filed: May 9, 2006

(30) Foreign Application Priority Data
May 12, 2005 (DE) 10 2005 022 100.9

(51) Int. Cl. C08L 83/04; B32B 27/00

(52) U.S. Cl. 525/477; 524/863; 524/588

(57) ABSTRACT

Dispersions of crosslinked organopolysiloxanes comprises reacting siloxanes (1)

$${A}_{a} {R}_{b} {X}_{c} {SiO}_{\frac{4 - ( a + b + c )}{2}}$$

where A, X, R, a, b, and c are defined herein, the sum a+b+c≦3, and there are at least one radical A and one radical —OR¹ per molecule where R¹ is H and/or siloxanes (2) containing units

$${{R}_{b} ( {OR}^{1} )}_{d} {SiO}_{\frac{4 - ( b + d )}{2}}$$

where d is 0 or 1, the sum b+d≦3, and there is at least one radical R¹ which is hydrogen, or mixtures thereof,
with silanes WRₚSi(oR⁷)₃₋ₚ
or hydrolysis products thereof, where W is a monovalent radical —CR⁶₂—Y, where Y is a monofunctional halogen, monosubstituted O or S, or substituted N or P radical, R⁶ and R⁷ are as defined herein, and p is 0, 1 or 2, the presence of dispersion medium and emulsifiers, with the proviso that no metal-containing catalysts are used, and that siloxanes (1) and/or (2) and silanes (3) are present such that crosslinked organopolysiloxanes insoluble in toluene are obtained.

### BACKGROUND OF THE INVENTION

1. Field of the Invention

The invention relates to a process for preparing dispersions of crosslinked organopolysiloxanes, to dispersions of crosslinked organopolysiloxanes prepared thereby, and to shaped bodies produced therefrom.

2. Background Art

For the preparation of polysiloxanes with high viscosity there exists a variety of methods. U.S. Pat. No. 5,942,574 discloses the preparation of emulsions from starting materials with a high viscosity of up to 10,000,000 mPa·s. For that purpose it is necessary, however, to have specially constructed, heavy extruders. The resultant emulsions are very coarse and of low stability. These emulsions contain silicones which, though highly viscous, are not crosslinked.

Emulsions of crosslinked silicones are likewise known. For the crosslinking of the silicones, crosslinkers are required as well as catalysts which may contain (heavy) metal or which may be metal-free. In some cases, inhibitors are used as well, for the purpose of controlling reactivity and pot life, for example to prevent unwanted premature gelling.

According to U.S. Pat. No. 5,001,187, OH-terminal polydimethylsiloxanes are polymerized in emulsion under acidic conditions, and, with addition of tin compounds as catalyst and evaporation to remove water, an elastomer film is formed over the course of 7 days.

US 2001/0027233 A1 describes a similar preparation of elastomer from a two-component system. One emulsion comprises OH-terminal polydimethylsiloxanes and crosslinker in emulsified form. The second emulsion comprises the tin catalyst. After the two emulsions have been mixed, the components react under tin catalysis. This forms a suspension having crosslinked particles of relatively low size and enhanced dispersability in resins.

U.S. Pat. No. 4,894,412 describes a self-crosslinking aminosiloxane emulsion which is prepared at 70° C. in a three-day, base-catalyzed reaction encompassing a plurality of process steps and using seven components. After the water has been removed, a flexible, rubberlike film is obtained.

EP 0 874 017 B1 discloses chain extension reactions employing metal catalysis. The silicones obtained are oils having viscosities of up to 75,000,000 mm²/sec, but no films, whether hard or elastomeric, and no powders, are obtained.

Water-based RTV-1 (one-component, room temperature-crosslinking) mixtures likewise employ metal-containing catalysts in order to impart high reactivity, rapid filming, etc., as described for example in U.S. Pat. No. 5,861,459. In order to obtain further desired elastomer film properties, such as adhesion, a multiplicity of additives are required, for example amino-functional organopolysiloxanes or special silicone resins, which must themselves be prepared in a separate step, which is costly and inconvenient.

Metal-free aqueous RTV-1 dispersions are composed, as disclosed in EP 828 794 B1, of at least the following 3 components: organopolysiloxanes containing condensable groups; (amine-free) organosilicon compounds which function as crosslinkers and have at least 3 crosslinking-reactive groups; and basic, N-containing organosilicon compounds; plus emulsifier(s) and water to form the dispersion. EP 655 475 B1 identifies specific silicone resins as crosslinker molecules.

This review of the prior art indicates that both the preparation of silicone emulsions which dry to form hard or elastomeric silicone networks, as well as the compositions prepared thereby, are unsatisfactory. The known emulsions of crosslinkable silicones are of complex construction in terms of formula and preparation processes, and are composed typically of a plurality of required components. As a result of the varying properties of the individual components and also of their influences on one another in the emulsion under preparation, it is difficult to achieve consistent quality on the part of the crosslinked silicone in the emulsion. Furthermore, solvents and catalysts, especially metal-containing catalysts, are undesired due to their toxicological, environmentally adverse or other unfavorable properties, such as impairment of the emulsion's storage stability.

DE-A 2500020 describes a process for preparing aminosiloxanes that reacts silanol-terminated polysiloxanes with α-amino silanes which carry one alkoxy group. The reaction proceeds at moderate temperatures with elimination of alcohol. This process produces only end-stopped organopolysiloxanes, not crosslinked organopolysiloxanes.

### SUMMARY OF THE INVENTION

An object of the invention was therefore to provide dispersions of crosslinked hard or elastomeric organopolysiloxanes, and also a simple and reliably implementable process for preparing these dispersions, with which the aforementioned disadvantages are avoided. The dispersions prepared thereby desirably form, on evaporation of the water, hard or elastomeric films or powders which have effective adhesion to different substrates. A further object was to provide emulsions of crosslinked organopolysiloxanes which contain Si—C bonded radicals bearing basic nitrogen groups. The process desirably omits chemical reaction steps requiring separate implementation, in particular omits reactions which require heating, and requires only a few starting materials. A still further object was to provide dispersions of crosslinked organopolysiloxanes that are low in particle size, stable, and preferably pH-neutral (pH range approximately 5-8). A yet further object was to provide dispersions of crosslinked organopolysiloxanes that are free, or virtually free, from volatile organic compounds (VOCs). These and other objects are achieved by means of the invention, whereby specific crosslinked organopolysiloxanes are reacted in dispersion with specific silanes in the absence of metal catalysts.

### DETAILED DESCRIPTION OF THE PREFERRED EMBODIMENT(S)

The invention thus provides a process for preparing dispersions of crosslinked organopolysiloxanes by reacting siloxanes selected from the group consisting of siloxanes (1) composed of units of the general formula

$${A}_{a} {R}_{b} {X}_{c} {SiO}_{\frac{4 - ( a + b + c )}{2}} \qquad ( I )$$

where
R is a hydrogen atom or a monovalent hydrocarbon radical having 1 to 200 carbon atoms, preferably 1-18 carbon atoms, optionally substituted by halogen, amine, ammonium, mercapto, acrylate or maleimide groups,
X is a radical of the general formula —OR¹, a chlorine atom, a radical of the formula —O⁻, where for charge compensation there may be protons and/or organic or inorganic ionic substances present, or a radical of the general formula II
   —(R²)ₕ—[OCH₂CH₂]ₑ[OC₃H₆]_{f}[OC₄H₈)₄]_{g}OR³ (II),
   where
R¹ is a hydrogen atom or a hydrocarbon radical having 1 to 200 carbon atoms, preferably 1-18 carbon atoms, optionally interrupted by one or more identical or different heteroatoms selected from O, S, N and P,
R² is a divalent hydrocarbon radical having 1 to 200 carbon atoms, preferably 2-10 carbon atoms, which may be interrupted by one or more groups of the formulae —C(O)—, —C(O)O—, —C(O)NR¹, —NR¹—, —N⁺HR¹—, —O—, —S— and/or may be substituted by F, Cl or Br,
R³ has the definition of R¹, or is a radical of the formulae C(O)R¹ or —Si(R¹)₃,
A is a radical of the general formula III
   —R⁴(B)_{z} (III),
   where
R⁴ is a divalent, trivalent or tetravalent hydrocarbon radical having 3 to 200 carbon atoms per radical, preferably 3 to 18 carbon atoms per radical, which may be interrupted by one or more groups of the formulae —C(O)—, —C(O)O—, —C(O)NR⁵, —NR⁵—, —N⁺HR⁵—, —N⁺R⁵R⁵—, —O—, —S—, —(HO)P(O)— or —(NaO)P(O)— and/or may be substituted by F, Cl or Br, where
R⁵ is a hydrogen atom or a hydrocarbon radical having 1 to 200 carbon atoms per radical, preferably 1-18 carbon atoms, which may be interrupted by one or more groups of the formulae —C(O)—, —C(O)O—, —C(O)NR⁵—, —NR⁵—, —N⁺HR⁵—, —N⁺R⁵R⁵—, —O— or —S— and/or may be substituted by F, Cl or Br, B can have a definition of R⁵ or is a radical selected from —COO—, —SO₃—, —OPO₃H_{y}—, —N⁺R⁵R⁵R⁵, —P⁺R⁵R⁵R⁵, —NR⁵R⁵, —OH, —SH, F, Cl, Br, —C(O)H, —COOH, —SO₃H, —C₆H₄—OH and —CₘF₂ₘ₊₁, 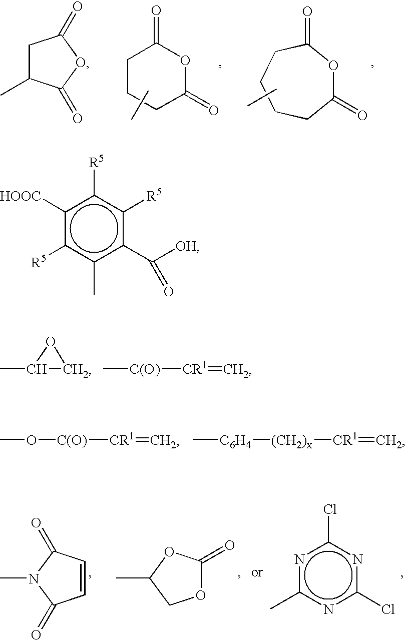
x is an integer of 1-20,
y is 0 or 1,
z, depending on the valence of R⁴, is 1, 2 or 3,
h is 0 or 1,
m is an integer of 1-20,
a, b, and c are each 0, 1, 2 or 3, with the proviso that sum a+b+c≦3, and e, f and g are each an integer 0-200, with the proviso that the sum e+f+g>1, with the proviso that there is at least one radical A per molecule and that there is at least one radical X per molecule which is a radical —OR¹ where R¹ is a hydrogen atom,
siloxanes (2) composed of units of the general formula

$${{R}_{b} ( {OR}^{1} )}_{d} {SiO}_{\frac{4 - ( b + d )}{2}} , \qquad ( VI )$$

where R, R¹, and b are as defined above and d is 0 or 1, with the proviso that the sum b+d≦3 and there is at least one radical R¹ per molecule which is a hydrogen atom,
and mixtures of siloxanes (1) and (2);
with silanes (3) of the general formula
   WRₚSi(OR⁷)₃₋ₚ (VII),
   or hydrolysis products thereof,
   where
W is a monovalent radical of the formula —CR⁶₂—Y,
R is as defined above,
R⁶ is a hydrogen atom or an alkyl radical having 1 to 4 carbon atoms, preferably a hydrogen atom,
Y is a monofunctional radical from the group consisting of halogens, monosubstituted atoms O and S and substituted atoms N and P,
R⁷ is an alkyl radical having 1 to 8 carbon atoms per radical, and
p is 0, 1 or 2, preferably 0 or 1, more preferably 0,
   in the presence of dispersion media (4), preferably water, and emulsifiers (5), and if desired, of further substances (6) which do not participate directly in the reaction, preferably water-miscible or water-immiscible liquids and/or water-soluble or water-insoluble solids, with the proviso that no metal-containing catalysts are used, and that siloxanes (1) and/or (2) and silanes (3) are selected in terms of identity and quantity such as to give organopolysiloxanes which are crosslinked and therefore insoluble in toluene.

Additionally the siloxanes (1) and/or (2) may if desired include units of the general formulae (IV) and (V) 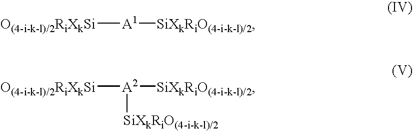
where
A¹ is a divalent radical R²,
A² is a trivalent hydrocarbon radical having 1 to 200 carbon atoms, preferably 1 to 18 carbon atoms, which may be interrupted by radicals of the formulae —C(O)—, —C(O)O—, —C(O)NR⁵, —NR⁵—, —N⁺HR⁵—, —N⁺R⁵R⁵—, —O—, —S—, —N— or —N⁺R⁵— and/or may be substituted by F, Cl or Br,
i and k are each 0, 1 or 2, with the proviso that i+k≦2, and
R and X are as defined above.

Charge compensation in the radicals A, A¹, A², R², R⁴, R⁵, B and X may where appropriate be accomplished through the presence of protons and/or organic or inorganic ionic substances, such as alkali metal ions, alkaline earth metal ions, ammonium ions, halide ions, sulfate ions, phosphate ions, carboxylate ions, sulfonate ions, and phosphonate ions.

The invention further provides dispersions, preferably emulsions, of crosslinked organopolysiloxanes comprising crosslinked organopolysiloxanes composed of units of the general formula

$${A}_{a} {R}_{b} {{W}_{n} ( {OR}^{1} )}_{d} {SiO}_{\frac{4 - ( a + b + d + n )}{2}} \qquad ( VIII )$$

where A, R, R¹, W, a, b, and d are as defined above and,
n is 0 or 1, with the proviso that the sum a+b+d+n≦3 and a and n are not simultaneously 1 in the same siloxane unit, and that on average there is at least one radical W per molecule, dispersion media (4), preferably water, and emulsifiers (5), and if desired, further substances (6), which do not participate directly in the reaction, with the proviso that there are no metal-containing catalysts present and that the organopolysiloxanes are crosslinked and therefore insoluble in toluene.

The crosslinked organopolysiloxanes of the invention have high-molecular weight branched or dendrimer-like, highly branched structures and this crosslinking results in hard or elastomeric compounds: hence no viscosity measurement is possible. The crosslinked organopolysiloxanes are typically insoluble in organic solvents such as toluene, but possibly swell therein, and such behavior is likewise considered to represent insolubility for the purposes of this invention. In contrast, viscosity measurements are possible for noncrosslinked liquid organopolysiloxanes, even those of high viscosity. Characteristic of noncrosslinked organopolysiloxanes is their solubility in organic solvents, such as toluene.

The crosslinked organopolysiloxanes of the invention may have branched, dendrimer-like highly branched, or crosslinked structures. These crosslinked organopolysiloxanes can be isolated from the dispersion as hard or elastomeric, shaped bodies, such as films. The dispersions of the invention are preferably aqueous suspensions or aqueous emulsions of crosslinked organopolysiloxanes.

The crosslinked organopolysiloxane dispersions dry to form, without addition of catalyst or alteration of pH, a hard or elastic silicone network. Preferably, for the preparation of the crosslinked organopolysiloxanes of the invention, only OH-terminal polyorganosiloxanes and rapidly reacting crosslinkers are needed, and these components react with one another preferably at room temperature. To assist the reaction there is no need for additional metal-containing catalysts. Furthermore, the reaction preferably proceeds in the neutral range, i.e., in a pH range from approximately 5 to 8, which comes about as a result of the components themselves. As a result of the high reactivity, there is furthermore no need for a controlled chemical reaction, and nor, preferably, for heating. The dispersions may optionally include further components (6), such as water-miscible or water-immiscible liquids, silicone or nonsilicone emulsions, further silanes or silicones, for example, as adhesion promoters, and also water-soluble or water-insoluble solids, especially water-insoluble solids, which serve as reinforcing or nonreinforcing fillers.

The dispersions of the invention are notable for their high storage stability, even at an elevated temperature, and for their high stability to shear. The process of the invention has the advantage that dispersions of low viscosity in tandem with high solids content and filler content can be obtained.

In the process of the invention no metal-containing catalysts are used; that is, there are preferably no transition metals from transition group VIII of the Periodic Table of the Elements, or their compounds, and no metals from main groups III, IV or V of the Periodic Table of the Elements, or their compounds, the elements C, Si, N and, and P not being regarded as metals for the purposes of this definition.

The fact that aqueous dispersions of crosslinked organopolysiloxanes can be obtained by the process of the invention was surprising, since A. Adima et al., Eur. J. Org. Chem. 2004, 2582-2588 describes how α-aminomethyltrialkoxy silanes decompose in the presence of water to form SiO₂ and the corresponding methylated amine.

Examples of hydrocarbon radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, and cycloheptyl and methylcyclohexyl radicals; alkenyl radicals such as the vinyl, 5-hexenyl, cyclohexenyl, 1-propenyl, allyl, 3-butenyl, and 4-pentenyl radicals; aryl radicals such as the phenyl, naphthyl, anthryl and phenanthryl radicals; alkaryl radicals such as the o-, m-, and p-tolyl radicals, xylyl radicals, and ethylphenyl radicals; and aralkyl radicals such as the benzyl radical, and the α- and the β-phenylethyl radicals.

Preference is given as radical R to the hydrogen atom or the methyl, ethyl, octyl, and phenyl radicals, particular preference being given to the hydrogen atom and to the methyl and ethyl radicals.

Examples of halogenated radicals R are haloalkyl radicals, such as the 3,3,3-trifluoro-n-propyl radical, the 2,2,2,2′,2′,2′-hexafluoroisopropyl radical, the heptafluoroisopropyl radical, and haloaryl radicals, such as the o-, m- and p-chlorophenyl radicals.

Examples of radicals R¹ are the alkyl radicals listed above for R and also the methoxyethyl and ethoxyethyl radicals, the radical R¹ preferably being hydrogen or alkyl radicals having 1 to 18 carbon atoms which may be interrupted by oxygen atoms, more preferably hydrogen and the methyl and the ethyl radicals.

Examples of organic or inorganic substances for charge compensation where X═—O⁻ are alkali metal ions and alkaline earth metal ions, ammonium ions and phosphonium ions, and also monovalent or divalent metal ions, preferably alkali metal ions, more preferably Na⁺ and K⁺.

Examples of radicals X are the hydroxy, methoxy or ethoxy radical and radicals of the general formula (II), such as
—(CH₂)₃—(OCH₂CH₂)₃—OCH₃, —(CH₂)₃—(OCH₂CH₂)₆—OCH₃,
—(CH₂)₃—(OCH₂CH₂)₃₅—OCH₃, —(CH₂)₃—(OCH(CH₃)CH₂)₃—OCH₃,
—(CH₂)₃—(OCH(CH₃)CH₂)₆—OCH₃, —(CH₂)₃—(OCH(CH₃)CH₂)₃₅—OCH₃,
—(CH₂)₃—(OCH₂CH₂)₃—(OCH(CH₃)CH₂)₃—OCH₃,
—(CH₂)₃—(OCH₂CH₂)₆—(OCH(CH₃)CH₂)₆—OCH₃,
—(CH₂)₃—(OCH₂CH₂)₃₅—(OCH(CH₃)CH₂)₃₅—OCH₃,
—(CH₂)₃—(OCH₂CH₂)₃—OSi(CH₃)₃, —(CH₂)₃—(OCH₂CH₂)₆—OSi(CH₃)₃,
—(CH₂)₃—(OCH₂CH₂)₃₅—OSi(CH₃)₃,
—(CH₂)₃—(OCH₂CH₂)₃—OC(O)CH₃, —(CH₂)₃—(OCH₂CH₂)₆—OC(O)CH₃,
—(CH₂)₃—(OCH₂CH₂)₃₅—OC(O)CH₃,
—(OCH₂CH₂)₃—OH, —(OCH₂CH₂)₆—OH, —(OCH₂CH₂)₃₅—OH,
—(OCH(CH₃)CH₂)₃—OH, —(OCH(CH₃)CH₂)₆—OH,
—(OCH(CH₃)CH₂)₃₅—OH, —(OCH₂CH₂)₃—(OCH(CH₃)CH₂)₃—OH,
—(OCH₂CH₂)₆—(OCH(CH₃)CH₂)₆—OH,
—(OCH₂CH₂)₃₅—(OCH(CH₃)CH₂)₃₅—OH;
—(OCH₂CH₂)₁₈—(O(CH₂)₄)₁₈—OH
—(OCH₂CH₂)₃—OCH₃, —(OCH₂CH₂)₆—OCH₃, —(OCH₂CH₂)₃₅—OCH₃,
—(OCH(CH₃)CH₂)₃—OCH₃, —(OCH(CH₃)CH₂)₆—OCH₃,
—(OCH(CH₃)CH₂)₃₅—OCH₃, —(OCH₂CH₂)₃—(OCH(CH₃)CH₂)₃—OCH₃,
—(OCH₂CH₂)₆—(OCH(CH₃)CH₂)₆—OCH₃,
—(OCH₂CH₂)₃₅—(OCH(CH₃)CH₂)₃₅—OCH₃,
—(OCH₂CH₂)₃—OSi(CH₃)₃, —(OCH₂CH₂)₆—OSi(CH₃)₃,
—(OCH₂CH₂)₃₅—OSi(CH₃)₃,
—(OCH₂CH₂)₃—OC(O)CH₃, —(OCH₂CH₂)₆—OC(O)CH₃,
—(OCH₂CH₂)₃₅—OC(O)CH₃,
—(OCH₂CH₂)₃—OH, —(OCH₂CH₂)₆—OH, —(OCH₂CH₂)₃₅—OH,
—(OCH(CH₃)CH₂)₃—OH, —(OCH(CH₃)CH₂)₆—OH,
—(OCH(CH₃)CH₂)₃₅—OH, —(OCH₂CH₂)₃—(OCH(CH₃)CH₂)₃—OH,
—(OCH₂CH₂)₆—(OCH(CH₃)CH₂)₆—OH,
—(OCH₂CH₂)₃₅—(OCH(CH₃)CH₂)₃₅—OH, and
—(OCH₂CH₂)₁₈—(O(CH₂)₄)₁₈—OH.

Examples of radicals R² are linear or branched, substituted or unsubstituted hydrocarbon radicals preferably having 2 to 10 carbon atoms, preference being given to saturated or unsaturated alkylene radicals, and particular preference being given to the ethylene and propylene radicals.

Examples of radicals R³ are the alkyl and aryl radicals listed above for R and radicals of the formula —C(O)R¹ or —Si(R¹)₃, preference being given to the methyl, ethyl, propyl, and butyl and also trialkylsilyl and —C(O)-alkyl radicals, and particular preference given to the methyl, butyl, —C(O)—CH₃, and the trimethylsilyl radical.

Examples of R⁴ are radicals of the formulae
—(CH₂)₃—,
—(CH₂)₃—O—CH₂—,
—(CH₂)₃—O—(CH₂—CH₂O)ₙ—,
—(CH₂)₃—O—CH₂—CH(OH)—CH₂—,
—(CH₂)₃—NH—(CH₂)₂—,
—(CH₂)₃—NH—C(O)—,
—(CH₂)₃—NH—(CH₂)₂—C(O)—O—,
—(CH₂)₃—NH—(CH₂)₂—C(O)—O—(CH₂)₂—,
—(CH₂)₃—NH—(CH₂)₂—NH—C(O)—CH═CH—,
—(CH₂)₃—NH—C(O)—CH═CH—,
—(CH₂)₃—C₆H₄—,

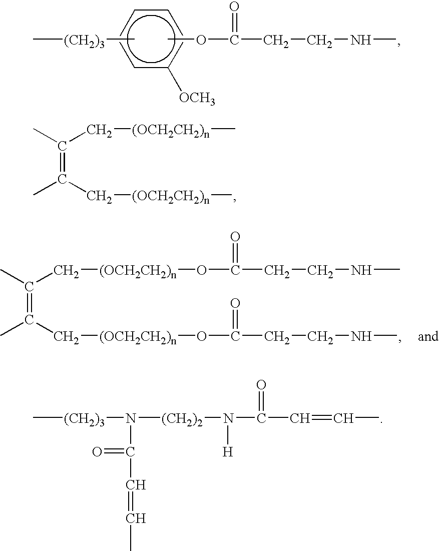

Preferred for R⁴ are radicals of the formulae
—(CH₂)₃—,
—(CH₂)₃—NH—(CH₂)₂—,
—(CH₂)₃—O—CH₂—CH(OH)—CH₂—, 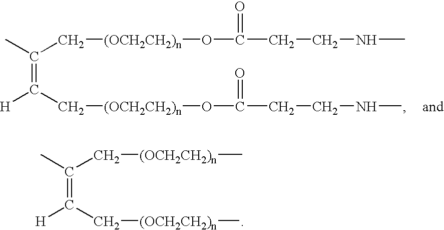
   Particularly preferred as R⁴ are —(CH₂)₃— and —(CH₂)₃—NH—(CH₂)₂—.

Examples of R⁵ are the alkyl and aryl radicals listed above for R, and radicals of the formulae
—C(O)—CH₃,
—(CH₂CH₂O)₃—CH₃, —(CH₂CH₂O)₆—CH₃, —(CH₂CH₂O)—CH₃,
—(CH(CH₃)CH₂O)₃—CH₃, —(CH(CH₃)CH₂O)₆—CH₃,
—(CH(CH₃)CH₂O)₃₅—CH₃, —(CH₂CH₂O)₃—(CH(CH₃)CH₂O)₃—CH₃,
—(CH₂CH₂O)₅—(CH₂—CH(CH₃)O)₅—CH₃,
—(CH₂CH₂O)₁₀—(CH₂—CH(CH₃)O)₁₀—CH₃,
—(CH₂CH₂O)₃—Si(CH₃)₃, —(CH₂CH₂O)₆—Si(CH₃)₃, —(CH₂CH₂O)₃₅—Si(CH₃)₃,
—(CH₂CH₂O)₅—(CH₂—CH(CH₃)O)₅—Si(CH₃)₃,
—(CH₂CH₂O)₁₀—(CH₂—CH(CH₃)O)₁₀—Si(CH₃)₃,
—(CH₂CH₂O)₃—C(O)CH₃, —(CH₂CH₂O)₆—C(O)CH₃, —(CH₂CH₂O)₃₅—C(O)CH₃, —(CH₂CH₂O)₅—(CH₂—CH(CH₃)O)₅—C(O)CH₃,
—(CH₂CH₂O)₁₀—(CH₂—CH(CH₃)O)₁₀—C(O)CH₃,
—(CH₂CH₂O)₃—H, —(CH₂CH₂O)₆—H, —(CH₂CH₂O)₃₅—H,
—(CH(CH₃)CH₂O)₃—H, —(CH(CH₃)CH₂O)₆—H,
—(CH(CH₃)CH₂O)₃₅—H, —(CH₂CH₂O)₃—(CH(CH₃)CH₂O)₃—H,
—(CH₂CH₂O)₅—(CH₂—CH(CH₃)O)₅—H,
—(CH₂CH₂O)₁₀—(CH₂—CH(CH₃)O)₁₀—H, and
—(CH₂CH₂O)₁₈—((CH₂)₄O)₁₈—H
   Preference as radical R⁵ is given to the hydrogen atom and to alkyl and aryl radicals, particular preference to the hydrogen atom and alkyl radicals.

Examples of radicals B are —COONa, —SO₃Na, —COOH, —SH, and, in particular, —OH, —NH₂, —NH—CH₃, —NH—(C₆H₁₁), and —N—(CH₂—CH═CH₂)₂, particular preference being given to —NH₂, —NH—CH₃ and —NH—(C₆H₁₁).

Examples of alkyl radicals R⁷ are the methyl, ethyl, n-propyl, isopropyl, 1-n-butyl, 2-n-butyl, isobutyl, tert-butyl, n pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals, such as the 2,2,4-trimethylpentyl radical.

Preferred examples of radicals A are those of the formulae —(CH₂)₃—NH₂, —(CH₂)₃—NH—CH₃, —(CH₂)₃—NH-C₆H₁₁, and —(CH₂)₃—NH—(CH₂)₂—NH₂.

Examples of A¹ are linear or branched, divalent alkyl radicals having preferably 2 to 20 carbon atoms, or radicals of the formulae —(CH₂)₃—NH—(CH₂)₃—, —(CH₂)₃—NR⁵—(CH₂)₃—, —(CH₂)₃—(CH₂—CH₂O)ₑ−(CH₂₃) —, and —O—(CH₂—CH₂O)e— where e is as defined above.

An example of A² is N[(CH₂)₃—]₃.

Preferred siloxanes (1) are those of the general formula
(R¹O)R₂SiO(SiR₂O)ᵣ(SiRAO)ₛSiR₂(OR¹) (IX)
where A, R and R¹ are as defined above,
s is an integer from 1 to 30, and
r is 0 or an integer from 1 to 1000,
with the proviso that 25% to 100%, preferably 50% to 100%, of all radicals R¹ are hydrogen atoms.

Preferred siloxanes (2) are those of the general formula
(R¹O)R₂SiO(SiR₂O)ₜSiR₂(OR¹) (X)
where R and R¹ are as defined above and
t is an integer from 1 to 1000,
with the proviso that 25% to 100%, preferably 50% to 100%, of all radicals R¹ are hydrogen atoms, and also those siloxanes (resins) of the general formula
   [(R₃SiO_{1/2})_{q}(R₂SiO_{2/2})ᵤ(R₁SiO_{3/2})ᵥ(SiO_{4/2})_{w}] (XI)
   where R is as defined above and additionally R in formula (XI) may also be a radical of the formula —OR¹ (where R¹ is as defined above), with the proviso that there is at least one radical —OR¹ per molecule where R¹ is a hydrogen atom, q, u, v, and w are each an integer from 0 to 1000, and v/(q+u+v+w) is preferably >0.2. Particular preference is given to using siloxanes (2) in the reaction.

Examples of siloxanes (1) are commercially customary functionalized siloxanes, such as amine oils, examples being amine oils having 3-(2-aminoethyl)aminopropyl functionality, glycol oils, and phenyl oils or phenylmethyl oils containing silanol groups. Examples of siloxanes (2) are commercially customary polydimethylsiloxanes having terminal silanol groups. Further examples of (2) are resinous siloxanes, examples being methylsilicone resins containing 80 mol % CH₃SiO_{3/2} and 20 mol % (CH₃)₂SiO_{2/2} and having a molar mass of approximately 5000 g/mol, or 98 mol % CH₃SiO_{3/2} and 2 mol % (CH₃)₂SiO_{2/2} with a molar mass of approximately 5000 g/mol, or, for example, methylphenylsilicone resins containing 65 mol % C₆H₅SiO_{3/2} and 35 mol % (CH₃)₂SiO_{2/2}, the remaining free valences carrying R¹O groups with the above definition. These examples are illustrative and not limiting.

These compounds are produced commercially in large quantities and are available at very favorable cost, thereby rendering the process of the invention particularly attractive from an economic standpoint.

The organopolysiloxanes (1) and (2) preferably have viscosities of 1 mPa·s to 50,000,000 mPa·s at 25° C., more preferably 50 mPa·s to 10,000,000 mPa·s at 25° C., and most preferably, 100 mPa·s to 500,000 mPa·s at 25° C.

Examples of radicals Y are fluorine, chlorine, bromine or iodine substituents, the groups —OH or —OR⁸, the groups —SH or —SR⁸, the groups —NH₂, —NHR⁸, —NR⁸₂ or —NR⁹, and the groups —PR⁸₂, —P(OR⁸)₂, and —PO(OR⁸)₂, where R⁸ is a monovalent organic radical with or without N and/or O atoms, preferably a monovalent hydrocarbon radical having 1 to 18 carbon atoms with or without N and/or O atoms, and R⁹ is a divalent hydrocarbon radical having 3 to 12 carbon atoms with or without N and/or O atoms.

Examples of radicals W are hydroxymethyl, methoxymethyl, ethoxymethyl, 2-ethoxyethoxymethyl, 2-butoxyethoxymethyl, acetoxymethyl, mercaptomethyl, ethylthiomethyl, dodecylthiomethyl, aminomethyl, methylaminomethyl, dimethylaminomethyl, diethylaminomethyl, dibutylaminomethyl, cyclohexylaminomethyl, anilinomethyl, 3-dimethylaminopropylaminomethyl, bis(3-dimethylaminopropyl)aminomethyl, n-morpholinomethyl, piperazinomethyl, piperidinomethyl, ((diethoxy-methylsilyl)methyl)cyclohexylaminomethyl, ((triethoxysilyl)-methyl)cyclohexylaminomethyl, diethylphosphinomethyl, and dibutylphosphinomethyl radicals, and also groups of the formulae —CH₂NHCOR⁸, —CH₂NHCO₂R⁸ or —CH₂NHCONHR⁸, R⁸ being as defined above. Preferably W is a radical of the formula —CH₂NHR⁸, —CH₂NR⁸₂ or —CH₂—NR⁹ where R⁸ and R⁹ are as defined above. Examples of hydrocarbon radicals R apply in full to hydrocarbon radicals R⁸. One preferred example of R⁹ is the radical of the formula —CH₂—CH₂—O—CH₂—CH₂—.

Examples of silanes (3) are
2-butoxyethoxymethyltrimethoxysilane,
methoxymethylmethyldiethoxysilane,
diethylaminomethylmethyldimethoxysilane,
dibutylaminomethyltriethoxysilane,
dibutylaminomethyltributoxysilane,
cyclohexylaminomethyltrimethoxysilane,
cyclohexylaminomethyltriethoxysilane,
cyclohexylaminomethylmethyldiethoxysilane,
anilinomethyltriethoxysilane,
anilinomethylmethyldiethoxysilane,
morpholinomethyltriethoxysilane,
morpholinomethyltrimethoxysilane,
morpholinomethyltriisopropoxysilane,
3-dimethylaminopropylaminomethyltrimethoxysilane,
acetylaminomethylmethyldimethoxysilane,
ethylcarbamoylmethyltrimethoxysilane,
(isocyanatomethyl)triethoxysilane,
(isocyanatomethyl)trimethoxysilane
(methacryloxymethyl)triethoxysilane,
(methacryloxymethyl)trimethoxysilane,
chloromethyltriethoxysilane,
chloromethyltrimethoxysilane,
morpholinomethyltributoxysilane,
morpholinomethyltrialkoxysilane, the alkoxy radical being a C₁ to C₄-alkoxy radical,
in particular a mixture of methoxy and ethoxy radical,
bis(dimethylaminopropyl)aminomethyltriethoxysilane,
diisopropylaminomethyltriethoxysilane,
diethylphosphonatomethyltrimethoxysilane,
piperazinomethyltriethoxysilane,
piperidinomethyltriethoxysilane,
bis(diethoxymethylsilylmethyl)cyclohexylamine,
bis(triethoxysilylmethyl)cyclohexylamine,
mercaptomethyltriethoxysilane, and
morpholinomethyltri(2-hydroxyethoxy)silane.

Preference is given to silanes (3) which carry a trialkoxy group, i.e., in which p in formula (VII) is 0.

In the process of the invention, it is preferred to use silanes (3) in amounts from 0.001% to 10% by weight, more preferably 0.01% to 5.0% by weight, and most preferably 0.1% to 3.0% by weight, based in each case on siloxane (1) and siloxane (2).

The dispersions of crosslinked organopolysiloxanes of the invention are prepared by intensely mixing siloxanes (1) and/or siloxanes (2), silanes (3), dispersion media (4) (preferably water), and emulsifiers (5), and if desired, further substances (6) with one another. Preparation may take place continuously or batchwise.

Technologies for preparing dispersions or emulsions of organopolysiloxanes are known. Thus the intense mixing and dispersing may take place in rotor/stator stirring apparatus, colloid mills, high-pressure homogenizers, microchannels, membranes, jet nozzles and the like, or by means of ultrasound. Homogenizing apparatus and techniques are described for example in Ullmann's Encyclopedia of Industrial Chemistry, CD-ROM edition, 2003, Wiley-VCH Verlag, under the heading “Emulsions”.

Although, as is known, the silanes (3) contain groups which are sensitive to hydrolysis, particularly if R³ is a methyl or ethyl radical, it is surprising that, even in the presence of water, crosslinked organopolysiloxanes are obtained as a result of condensation of two or more siloxanes (1) and/or siloxanes (2).

The way in which the components used to prepare the dispersions of the invention are mixed is not very critical and can be performed in various orders. Depending on the components (1), (2), (3), (4), (5), and (6).

For example, components (1) and/or (2) and (3) may be premixed with one another, then the emulsifier(s) added, and subsequently the dispersion medium and any further substances (6) incorporated. Another possibility is to meter components (1) to (5) or to (6) in order into the emulsifying apparatus. In particular cases, owing to the siloxanes viscosity or reactivity for example, it may be advantageous to mix silane (3) with siloxane (1) and then to incorporate siloxane (2), or vice versa, depending on what produces more favorable Theological properties for processing the components.

In the case of highly reactive silanes (3) it may be advantageous first to convert component (1) and/or (2) into a stiff phase with emulsifier (5) and the dispersion medium (4), and subsequently to meter in the silane (3), in pure form or in dilution in an inert substance (6), prior to a phase inversion in order, for example, to produce an oil-in-water dispersion.

For the process of the invention dispersion medium (4), preferably water, is preferably used in amounts of 1% to 99% by weight, more preferably 5% to 95% by weight, based in each case on the total weight of all ingredients of the dispersion.

For the process of the invention it is possible as emulsifiers (5) to use ionic and nonionic emulsifiers, both individually and in the form of mixtures of different emulsifiers, which are suitable for preparing aqueous dispersions of organopolysiloxanes. It is likewise possible, as is known, to use inorganic solids as emulsifiers (5). These are, for example, silicas or bentonites as described in EP 1017745 A or DE 19742759 A.

Examples of Anionic Emulsifiers are as Follows:

1. Alkyl sulfates, particularly those having a chain length of 8 to 18 carbon atoms, alkyl and alkaryl ether sulfates having 8 to 18 carbon atoms in the hydrophobic radical and 1 to 40 ethylene oxide (EO) and/or propylene oxide (PO) units.
2. Sulfonates, particularly alkylsulfonates having 8 to 18 carbon atoms, alkylarylsulfonates having 8 to 18 carbon atoms, taurides, esters, including monoesters, of sulfosuccinic acid with monohydric alcohols or alkylphenols having from 4 to 15 carbon atoms; if desired, these alcohols or alkylphenols may also have been ethoxylated with 1 to 40 EO units.
3. Alkali metal salts and ammonium salts of carboxylic acids having 8 to 20 carbon atoms in the alkyl, aryl, alkaryl or aralkyl radical.
4. Phosphoric acid partial esters and their alkali metal salts and ammonium salts, particularly alkyl and alkaryl phosphates having 8 to 20 carbon atoms in the organic radical, alkyl ether phosphates and alkylaryl ether phosphates having 8 to 20 carbon atoms in the alkyl or alkaryl radical and 1 to 40 EO units.
   Examples of Nonionic Emulsifiers are as Follows:
5. Polyvinyl alcohol still containing 5% to 50%, preferably 8% to 20%, of vinyl acetate units, with a degree of polymerization of 500 to 3000.
6. Alkyl polyglycol ethers, preferably those having 3 to 40 EO units and alkyl radicals of 8 to 20 carbon atoms.
7. Alkylaryl polyglycol ethers, preferably those having 5 to 40 EO units and 8 to 20 carbon atoms in the alkyl and aryl radicals.
8. Ethylene oxide/propylene oxide (EO/PO) block copolymers, preferably those having 8 to 40 EO/PO units.
9. Adducts of alkylamines having alkyl radicals of 8 to 22 carbon atoms with ethylene oxide or propylene oxide.
10. Fatty acids having 6 to 24 carbon atoms.
11. Alkylpolyglycosides of the general formula R*—O-Zₒ, in which R* is a linear or branched, saturated or unsaturated alkyl radical having on average 8-24 carbon atoms and Zₒ is an oligoglycoside residue containing on average o=1-10 hexose or pentose units or mixtures thereof.
12. Natural substances and derivatives thereof, such as lecithin, lanolin, saponins, cellulose; cellulose alkyl ethers and carboxyalkylcelluloses whose alkyl groups each possess up to 4 carbon atoms.
13. Linear organo(poly)siloxanes containing polar groups containing in particular the elements O, N, C, S and/or P, especially those having alkoxy groups with up to 24 carbon atoms and/or up to 40 EO and/or PO groups.
   Examples of Cationic Emulsifiers are as Follows:
14. Salts of primary, secondary, and tertiary fatty amines having 8 to 24 carbon atoms with acetic acid, sulfuric acid, hydrochloric acid, and phosphoric acids.
15. Quaternary alkylammonium and alkylbenzeneammonium salts, especially those whose alkyl groups possess 6 to 24 carbon atoms, particularly the halides, sulfates, phosphates, and acetates.
16. Alkylpyridinium, alkylimidazolinium, and alkyloxazolinium salts, especially those whose alkyl chain possesses up to 18 carbon atoms, particularly the halides, sulfates, phosphates, and acetates.
   Particularly Suitable Ampholytic Emulsifiers Include the Following:
17. Amino acids with long-chain substitution, such as N-alkyl-di(aminoethyl)glycine or N-alkyl-2-aminopropionic salts.
18. Betaines, such as N-(3-acylamidopropyl)-N,N-dimethylammonium salts having a C₈-C₁₈ acyl radical, and alkylimidazolium betaines.

Preferred emulsifiers are nonionic emulsifiers, especially the alkyl polyglycol ethers listed above under 6.

Constituent (5) may be composed of one of the abovementioned emulsifiers or of a mixture of two or more abovementioned emulsifiers, and may be used in pure form or as solutions of one or more emulsifiers in water or organic solvents.

In the process of the invention the emulsifiers (5) are preferably used in amounts of 0.1% to 60% by weight, more preferably 0.5% to 30% by weight, based in each case on the total weight of siloxanes (1) and/or (2) and silanes (3).

If the organosilicon compounds (1), (2) or (3) or the resultant crosslinked organosilicon compounds themselves act as emulsifiers, it is possible to forego the addition of separate emulsifier (5).

Examples of water-miscible liquids which can be used as further substances (6) are acids, for example, formic acid, acetic acid, propionic acid, phosphoric acid, hydrochloric acid, and/or sulfuric acid; or bases such as triethylamine, triethanolamine, and/or trioctylamine, as well as ethylene glycol or polyethylene glycol, 1,2-propanediol, 1,3-propanediol, polypropylene glycol, diethylene glycol monobutyl ether or glycerol. It is further possible to use dispersions or emulsions as further substances (6), examples being commercially available dispersions such as styrene-butadiene latex, acrylic, vinyl, polyurethane or polyethylene dispersions, and also emulsions of natural or synthetic oils, resins or waxes, such as carnauba wax, beeswax, lanolin, aloe vera, vitamin E, liquid paraffin, unreactive silicone oil, unreactive silicone resin, jojoba oil, rice oil, calendula oil, tea tree oil, rose oil or balm oil emulsions. As further substances (6) it is additionally possible to add commercially customary preservatives for dispersions, such as isothiazolinones or parabens, for example, or aqueous formulations thereof.

The dispersions can be prepared as dispersions of undiluted crosslinked organopolysiloxanes, although in certain cases, for reasons of handling, dilution is advisable with organic solvents or low-viscosity oligomers/polymers.

Examples of water-immiscible liquids which can be used as further substances (6) are therefore organic solvents, such as toluene, n-hexane, n-heptane, and technical petroleum fractions, and low-viscosity oligomers/polymers, preferably siloxanes, such as dimethylpolysiloxanes.

Examples of water-soluble solids which can be used as further substances (6) are, for example, inorganic salts such as alkali metal or alkaline earth metal halides, sulfates, phosphates, hydrogen phosphates, e.g., sodium chloride, potassium sulfate, magnesium bromide, calcium chloride, ammonium chloride, and ammonium carbonate, or salts of C₁ to C₈ carboxylic acids such as alkali metal or alkaline earth metal salts, e.g., sodium acetate.

Examples of water-insoluble solids which can be used as further substances (6) are reinforcing and nonreinforcing fillers. Examples of reinforcing fillers, which are fillers having a BET surface area of at least 50 m²/g, are pyrogenic silica, precipitated silica or silicon aluminum mixed oxides having a BET surface area of more than 50 m²/g. These fillers may have been rendered hydrophobic. Examples of nonreinforcing fillers, which are fillers having a BET surface area of less than 50 m²/g, are powders of quartz, chalk, crystobalite, diatomataceous earth, calcium silicate, zirconium silicate, montmorillonites, such as bentonites, zeolites, including the molecular sieves, such as sodium aluminum silicate, metal oxides, such as aluminum oxide or zinc oxide or their mixed oxides or titanium dioxide, metal hydroxides, such as aluminum hydroxide, barium sulfate, calcium carbonate, gypsum, silicon nitride, silicon carbide, boron nitride, powdered glass, powdered carbon, and powdered plastics, and hollow glass and plastic beads.

The emulsifying operation for preparing the dispersion is carried out preferably at temperatures below 120° C., more preferably at 5° C. to 100° C., most preferably at 10° C. to 80° C. The temperature increase preferably comes about through the introduction of mechanical shearing energy which is required for the emulsifying operation. The temperature increase is not needed in order to accelerate a chemical process. Furthermore, the process of the invention is preferably carried out under the pressure of the surrounding atmosphere, though it can also be carried out at higher or lower pressures.

Depending on whether di- or trialkoxysilane (3) and linear, branched or resinous siloxane (1) and/or (2) are employed, the crosslinked organopolysiloxanes may have branched or even highly branched/highly crosslinked structures with linear fractions.

Where dialkoxysilanes (3) are reacted with siloxanes (1) and/or (2) of purely linear construction, containing not more than 2 SiOH functions per molecule, in particular with the siloxanes of the formulae (IX) and (X), linear organopolysiloxanes of high viscosity are obtained, and not crosslinked organopolysiloxanes of the invention. The reaction of siloxanes (1) and/or (2) which contain more than 2 OH functions, in particular at least 3 OH functions, per molecule with dialkoxysilanes (3) does lead, in contrast, to crosslinked siloxane polymers.

Where trialkoxysilxanes are used as silanes (3), which is preferred, crosslinked organopolysiloxanes of the invention are obtained. Furthermore, when using mixtures of dialkoxysilanes (3) and trialkoxysilanes (3), particularly when using mixtures of 1%-99% by weight dialkoxysilanes (3) and 1%-99% by weight trialkoxysilanes (3), preferably 10%-90% by weight dialkoxysilanes (3) and 10%-90% by weight trialkoxysilanes (3), crosslinked organopolysiloxanes of the invention are also obtained. The degree of crosslinking here depends on the ratio that is employed of the equivalents of —OR⁷ in silane (3) to —OR¹ in siloxane (1) and/or (2).

Silane (3) is preferably used here in amounts such that there are at least 0.6 equivalent of —OR⁷, more preferably at least 0.7 equivalent of —OR⁷, yet more preferably 0.6 to 5 equivalents of —OR⁷, still more preferably 0.65 to 2 equivalents of —OR⁷, and in particular, 0.7 to 1.5 equivalents of —OR⁷, per equivalent of —OR¹ in siloxane (1) and/or (2), R¹ being preferably a hydrogen atom.

Monofunctional monoalkoxysilane reacts as a chain end stopper and can then be used in addition to trialkoxysilanes or in addition to mixtures of trialkoxysilanes and dialkoxysilanes, if it is desired that there should be groups “W” at the end of siloxane chains. Monofunctional monoalkoxysilanes are preferably not used.

The process of the invention has the advantage of proceeding without the use of catalysts, especially without the use of metal catalysts. The reaction of (1) and/or (2) with (3) preferably proceeds to completion within a few minutes to several hours, with methoxysilanes reacting more rapidly than ethoxysilanes. The condensation can be accelerated by means of acids and bases, although this is not preferred.

The alcohols obtained as condensation byproducts in the process of the invention may remain in the product or else can be removed by means of vacuum distillation, extraction, or other means.

The average particle size measured by means of light scattering within the dispersions is situated in the range 0.001 to 100 μm, preferably 0.002 to 10 μm. The pH values may vary from 1 to 14, preferably 3 to 9, more preferably 5 to 8.

The invention further provides shaped bodies prepared by removal of the dispersion medium (4), preferably water, from the dispersions of the invention, which are preferably emulsions. In this case, it is preferred to remove the water by drying the dispersions of the invention at a temperature of approximately 1 to 200° C., preferably 5 to 150° C., more preferably in the temperature range of the surrounding atmosphere, i.e., at approximately 10 to 30° C. The drying time in this case depends on the thickness of the shaped body and is preferably 0.1 to 100 hours, more preferably 0.2 to 48 hours.

The shaped bodies may be hard or elastomeric bodies. They are preferably coatings or self-supporting shaped bodies, such as self-supporting films. It is also possible to obtain hard or elastomeric powders by removing the dispersion medium (4), preferably water, by spray drying, fluidized-bed drying, or freeze drying the dispersions.

The invention further provides a method of producing coatings by applying the dispersion of the invention to a substrate and removing the dispersion medium (4), preferably water. The dispersion is preferably dried on the substrate. In contrast to coatings, self-supporting films do not adhere to the substrate on which they have been produced, and can be removed from the substrate. The invention further provides a method of impregnating or infiltrating substrates by applying the dispersion of the invention to a substrate, impregnating or infiltrating the substrate or its surface, and removing the dispersion medium (4), preferably water. The dispersion is preferably dried on the substrate. With regard to the substrates, the dispersions of the invention may remain substantially on the surface, and the substrate is impregnated, or else the dispersions may penetrate more deeply into the substrate, providing infiltration.

The application of the dispersions of the invention to the substrates that are to be coated or to the substrates or surfaces thereof that are to be impregnated or infiltrated can take place in any manner which is suitable for the production of coatings or impregnated systems from liquid materials, such as by dipping, spreading, pouring, spraying, rolling, printing, by means of an offset gravure coating apparatus, for example, by blade or knife coating, or by means of an air brush, for example. The coat thickness on the substrates to be coated is preferably 0.01 to 10,000 μm, more preferably 0.1 to 100 μm.

Examples of substrates which can be infiltrated or impregnated or coated with the dispersions of the invention include paper, wood, cork, plastics, polymeric films, such as polyethylene films, or polypropylene films, polyethylene-coated paper and boards, natural or synthetic fibers, woven and nonwoven cloth of natural or synthetic fibers, textiles, ceramic articles, glass, including glass fibers, stone, concrete, and metals. The dispersions of the invention can additionally be used as silicone sealants, as PSAs (pressure-sensitive adhesives), and in personal care compositions.

### EXAMPLE 1

In an Ultra-Turrax T 50 emulsifier (Janke & Kunkel) 5 g of isotridecyl decaethoxylate, 85% in water, available commercially under the trade name Lutensol TO 109 (BASF), and 8 g of demineralized water are used to produce an emulsifier mixture, to which 100 g of a freshly prepared homogeneous siloxane polymer/silane mixture are added, consisting of 99.65 g of polydimethylsiloxanediol having a terminal OH group content of 1100 ppm by weight, as siloxane (2), and 0.35 g of N-morpholinomethyltriethoxysilane as silane (3). Dilution is then carried out in portions with a total of 90.1 g of fully demineralized water, to give a milky white emulsion having an average particle size of 309 nm. The solids content of the emulsion is 50.7%, its pH 6.0. The emulsion remains homogeneous and stable even after 6-month storage at room temperature. Evaporating the emulsion after a drying time of 24 h at 25° C. produces a film of gel-like elasticity which has adhesive properties and adheres well to glass or aluminum.

### EXAMPLES 2 TO 6

Further emulsions are prepared in the same way as in Example 1, he amounts indicated in the table below:

| | Silox- | Silox- | Sil- | | | | Film |
|---|---|---|---|---|---|---|---|
| | ane | ane | ane | Solids | | Particle | assessment |
| Exam- | (1) | (2) | (3) | content | | size | after drying |
| ple | in g | in g | in g | (%) | pH | (nm) | 24 h/25° C. |
| 2 | — | 99.56 | 0.44 | 50.5 | 7 | 478 | very elastic, |
| | | (2a) | | | | | transparent |
| 3 | — | 99.40 | 0.60 | 49.9 | 7 | 481 | elastic, |
| | | (2a) | | | | | transparent |
| 4 | — | 99.22 | 0.79 | 50.5 | 6.5 | nd* | elastic, |
| | | (2a) | | | | | opaque, |
| | | | | | | | little |
| | | | | | | | adhesion |
| 5 | — | 94.0 | 6.0 | 49.8 | 8 | nd* | little |
| | | (2a) | | | | | elasticity, |
| | | | | | | | opaque |
| 6 | 20.0 | 80.0 | 0.37 | 52.0 | 7 | 2810 | very elastic, |
| | (1a) | (2a) | | | | | transparent |
| | | | | | | | tacky |

*nd = not determined

The solids content is determined to constant weight at 150° C. using the Mettler Toledo HR 73 apparatus. The particle sizes are determined using a Coulter N4 plus.
Siloxane (1a) used is:
Copolymer of 3-(2-aminoethylamino)propylmethylsiloxy and dimethylsiloxy units with an amine number of 0.145, a viscosity of 4700 mm²/s (at 25° C.), and an OH/OMe end group ratio of 54/46.
Siloxane (2a) used is:
Polydimethylsiloxanediol having a terminal OH group content of 1100 ppm by weight.
Silane (3) used is:
N-Morpholinomethyltriethoxysilane

The elasticity of the films produced from the emulsion decreases with increasing amount of silane (3) from examples 2 to 5. The elastomer film produced from Example 3 is cut and placed in toluene for 24 h. Thereafter the cut edges are still sharply defined. The film has swollen but is insoluble in toluene.

### EXAMPLE 7

In an Ultra-Turrax T 50 emulsifier (Janke & Kunkel) 2.5 g of isotridecyl decaethoxylate (Lutensol TO 109, BASF), and 8 g of water are used to prepare an emulsifier mixture to which 99 g of a freshly prepared homogeneous siloxane/silane mixture are added consisting of 97.56 g of polydimethylsiloxanediol (2a), 1.0 g of siloxane (1a), and 0.44 g of N-morpholinomethyltriethoxysilane. Dilution is then carried out in portions with a total of 8.9 g of water, to give a pastelike, milky white emulsion of firm consistency. The solids content of the emulsion is 86.3%. The emulsion paste remains homogeneous and stable even after 8-month storage at room temperature.

Evaporation of the emulsion at 25° C. produces skinning after just 45 minutes, and after 5 hours its state is virtually that of a compact film. After 24 h at 25° C. an elastic film is obtained which adheres to glass, paper or aluminum. The values measured on a standard dumbell S3A to DIN 53504-85 are as follows: elongation at break 680%, stress value at 100% elongation, 0.11 N/mm2. The emulsion paste is suitable for use as a joint sealant.

### EXAMPLE 8

In an Ultra-Turrax T 50 emulsifier (Janke & Kunkel) 4 g of isotridecyl pentadecaethoxylate, available commercially under the trade name Lutensol TO 15 (BASF), and 8 g of water are used to prepare an emulsifier mixture to which 100 g of a freshly prepared homogeneous siloxane/silane mixture are added consisting of 97.05 g of a silicone resin (²⁹Si NMR: 72.7 mol % CH₃SiO_{3/2}, 1.6 mol % (CH₃)₂SiO_{3/2}, and 25.7 mol % (CH₃)₂SiO_{1/2}; Zerewitinoff OH content: 5.8% by weight; viscosity 2640 mm²/s at 25° C.) and 3.0 g of cyclohexylaminomethyltriethoxysilane. Dilution is then carried out in portions with a total of 89.9 g of water, giving a milky white emulsion. The solids content of the emulsion is 47.9%. The emulsion remains homogeneous and stable even after 5-month storage at room temperature.

Evaporating the emulsion at 25° C. produces within 24 h a hard, transparent film of low elasticity which exhibits outstanding adhesion to glass, paper, aluminum or concrete.

### EXAMPLE 9

In the same way as in Example 1, a dispersion is prepared, using the following components:
5 g of isotridecyl decaethoxylate (Lutensol TO 109, BASF);
8 g of fully demineralized water;
100.65 g of a siloxane/silane mixture freshly prepared from 97.5 g of siloxane (2b) (polydimethylsiloxanediol having a terminal OH group content of 740 ppm by weight), 0.45 g of N morpholinomethyltriethoxysilane, and, additionally as substance (6), 2.5 g of N-(2-aminoethyl)(3-aminopropyl)methyldimethoxysilane;
90.1 g of fully demineralized water.

A milky white emulsion is formed. The solids content of the emulsion is 52.7%, its pH 8.5. The emulsion remains homogeneous and stable even after 3-month storage at room temperature.

Evaporating the emulsion at 25° C. produces within 24 h an elastic film which adheres well to glass, paper or aluminum. The silicone liner provided by this film is impeccable on paper and exhibits good release properties with respect to commercially customary adhesive labels.

### EXAMPLE 10

In the same way as in Example 1, a dispersion is prepared, using the following components:
8.1 g of partly hydrophobicized silica, prepared in accordance with EP 1 433 749 A1, in dispersion in 43.9 g of fully demineralized water,
99.0 g of a siloxane/silane mixture, freshly prepared from 1.0 g of siloxane (1a), 97.56 g of siloxane (2a), and 0.44 g of N-morpholinomethyltriethoxysilane, and
45.8 g of fully demineralized water.

A milky white emulsion is formed. The solids content of the emulsion is 52.1%, its pH 5.5. The emulsion remains homogeneous and stable even after 3-month storage at room temperature.

Evaporating the emulsion produces, after a drying time of 24 h at 25° C., an elastic film which adheres to glass and aluminum.

### EXAMPLE 11

In the same way as in Example 1, a dispersion is prepared, using the following components:
8.25 g of isotridecyl pentaethoxylate (Lutensol TO 5, BASF);
10.34 g of isotridecyl decaethoxylate (Lutensol TO 109, BASF);
16.5 g of Tagat S (1:1 in water), (Goldschmidt AG)
724.0 g of a siloxane/silane mixture, freshly prepared from
720.2 g of siloxane (2a), 3.98 g of N-morpholinomethyltriethoxysilane;
596.5 g of fully demineralized water.

A milky white emulsion is formed. The solids content of the emulsion is 53.8%, its pH 6.5. The emulsion remains homogeneous and stable even after 6-month storage at room temperature. Evaporating the emulsion produces, after a drying time of 24h at 25° C., an elastic, opaque film.

### EXAMPLE 12

Emulsion A:

In the same way as in Example 1, a dispersion is prepared, using the following components:
5 g of isotridecyl decaethoxylate (Lutensol TO 109, BASF);
8 g of fully demineralized water;
100.0 g of a siloxane/silane mixture, freshly prepared from
94 g of siloxane (2) (trimethylsilyl-end stoppered polydimethylsiloxane having a viscosity of 98 mm²/s at 25° C.) and 6.0 g of N-morpholinomethyltriethoxysilane;
90.0 g of fully demineralized water.
   Emulsion B:

In the same way as in Example 1, a dispersion is prepared, using the following components:
5 g of isotridecyl decaethoxylate (Lutensol TO 109, BASF);
8 g of fully demineralized water;
98.0 g of siloxane (2a);
90.0 g of fully demineralized water.
   Emulsion A and emulsion B, both of which are milky white, are mixed in a ratio of 50:8 parts by weight. By evaporation of the emulsion mixture, after a drying time of 24 h at 25° C., an elastic, readily adhering film is obtained whose surface is smooth to the touch.

### EXAMPLE 13

50 parts by weight of emulsion A from Example 12 are mixed with 8 parts by weight of the emulsion from Example 5. By evaporation of the emulsion mixture, after a drying time of 3 days at 25° C., an elastically tacky film is obtained which adheres well.

### EXAMPLE 14

To produce a microemulsion of an amine-containing, crosslinked silicone, first of all a homogeneous emulsifier mixture is prepared from 1.5 g of diethylene glycol monobutyl ether, 3.3 g of Lutensol TO 5 (BASF), 0.3 g of Marlipal ST 1618/25 (Sasol GmbH, Marl) and 0.07 g of 80% strength acetic acid. Incorporated into this premix with stirring is a fresh solution prepared from 0.055 g of N-morpholinomethyltriethoxysilane, 8.0 g of siloxane (1a) and 2.0 g of siloxane (2a), and then the mixture is slowly diluted with 14.5 g of deionized water. This gives a low viscosity, transparent microemulsion. Approximately 2 g of the microemulsion are dried at 50° C. Skinning has commenced after 1 hour. After a drying time of 5 hours at 50° C. an elastically tacky, opaque silicone film which adheres well has formed.

### EXAMPLE 15

To produce a microemulsion of a crosslinked silicone, 4 g of emulsion from Example 7 are mixed with 1.5 g of 1,2-propanediol. This produces a low viscosity, virtually clear microemulsion of crosslinked silicone. Evaporating the emulsion produces, after a drying time of 72 h at 20° C., an elastic, opaque film with a surface which is dry to the touch.

### EXAMPLE 16

4 parts by weight of a pyrogenic, highly disperse, hydrophilic silica (BET surface area: 150 m²/g) are mixed into 96 parts by weight of the emulsion from Example 7. A flowable powder is formed. After a drying time of 4 hours at 25° C. this mixture forms an elastic powder.

### EXAMPLE 17

52 parts by weight of the emulsion from Example 7 are diluted with 34 parts by weight of water and the diluted emulsion is mixed with 4.3 parts by weight of an SBR dispersion (type 85PI6 from Synthomer Ltd., Harlow, GB) as component (6). Evaporating this mixture produces, after a drying time of 24 h at 25° C., an elastic film which adheres well to glass.

### EXAMPLE 18

8 parts by weight of the emulsion from Example 7 are mixed with 1 part by weight of a 10% strength solution of polyvinyl alcohol in water (degree of hydrolysis of the PVA: 88%, viscosity of the 10% strength solution at 25° C.: 950 mm²/sec) as component (6). Evaporating this mixture produces, after a drying time of 24 h at 25° C., an elastic film which adheres well to glass and aluminum.

### EXAMPLE 19

In the same way as in Example 1, a dispersion is prepared, using the following components:
2.5 g of isotridecyl decaethoxylate (Lutensol TO 109, BASF);
8 g of fully demineralized water;
70.15 g of a siloxane/silane mixture, freshly prepared from
69.92 g of siloxane (2c) (polydimethylsiloxanediol having a terminal OH group content of 1900 ppm by weight), 0.23 g of N-morpholinomethyltriethoxysilane, and additionally as substance (6), 30 g of a trimethylsilyl-end stoppered polydimethylsiloxane having a viscosity of 102 mm²/s at 25° C.;
90.0 g of fully demineralized water.

A milky white emulsion is formed. The solids content of the emulsion is 51.7%, its pH 6.5. The emulsion remains homogeneous and stable even after 3-month storage at room temperature. Evaporating the emulsion produces, after a drying time of 48 h at 23° C., an elastic film.

### EXAMPLE 20

Example 1 is repeated in the same manner with the difference that instead of a mixture of siloxane (2a) and silane (3), 69.6 g of pure polydimethylsiloxanediol having a terminal OH group content of 1100 ppm by weight (described in Example 1), in three portions, and subsequently 30.39 g of a solution of 0.39 g of N-morpholinomethyltriethoxysilane in 30.00 g of a trimethylsilyl-end stoppered polydimethylsilicone oil with a viscosity of 350 mPa·s (25° C.), in two portions, are added. This is followed by identical dilution with water. With the same silicone content and solids content, the emulsion has a particle size of 294 nm. The emulsion shows no change after 5 days at 50° C.

### COMPARATIVE EXAMPLE C1 (NOT INVENTIVE)

Example 1 is repeated with the difference that instead of the siloxane polymer/silane mixture used in Example 1, 100 g of a freshly prepared homogeneous siloxane polymer/silane mixture consisting of 99.65 g of polydimethylsiloxanediol having a terminal OH group content of 1100 ppm by weight and 0.59 g of N-(2-aminoethyl)(3-aminopropyl)trimethoxysilane are added. This is followed by identical dilution with water, giving a milky white, homogeneous emulsion having an average particle size of 362 nm and a pH of 7. Evaporating the emulsion produces, even after a drying time of 12 days at 23° C., only an oil, which is soluble in toluene, but not a film possessing elastomeric properties.

### COMPARATIVE EXAMPLE C2 (NOT INVENTIVE)

In an Ultra-Turrax emulsifier T 50 (Janke & Kunkel) 9.38 g of isotridecyl decaethoxylate (Lutensol TO 109, BASF AG), 3.90 g of castor oil ethoxylate G 1300 (Atlas) and 4.55 g of water are used to produce a stiff emulsifier mixture, to which 125.28 g of a freshly prepared homogeneous polymer/silane mixture composed of 124.63 g of polydimethylsiloxanediol having a terminal OH group content of 765 ppm by weight and 0.86 g of N-morpholylmethylmethyldiethoxysilane is added. Dilution is then carried out in portions with a total of 106.65 g of water, giving a stable emulsion having an average particle size of 275 nm. The silicone content of the emulsion is 50%.

Following a standing time of 24 h at 25° C., and re-extraction of the siloxane polymer with n-heptane, the emulsion is evaporated and loses the solvent to give a highly viscous polysiloxane having a viscosity of 3400 Pa·s (25° C.) which is soluble in toluene and hence uncrosslinked. The dispersion comprising this highly viscous polysiloxane is not inventive.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for preparing a dispersion of crosslinked organopolysiloxanes, comprising reacting at least one siloxane (1) or at least one siloxane (2) or a mixture of at least one siloxane (1) and at least one siloxane (2) with at least one silane (3), wherein siloxanes (1) comprise units of the general formula
$${A}_{a} {R}_{b} {X}_{c} {SiO}_{\frac{4 - ( a + b + c )}{2}} \qquad ( I )$$
where
R is a hydrogen atom or a monovalent hydrocarbon radical having 1 to 200 carbon atoms optionally substituted by halogen, amine, ammonium, mercapto, acrylate or maleimide groups,
X is a radical of the formula —OR¹, a chlorine atom, a radical of the formula —O⁻, where for charge compensation there are protons and/or organic or inorganic ionic substances present, or is a radical of the formula II
—(R²)ₕ—[OCH₂CH₂]ₑ[OC₃H₆]_{f}[OC₄H₈)₄]_{g}OR₃ (II),
where
R¹ is a hydrogen atom or a hydrocarbon radical having 1 to 200 carbon atoms optionally interrupted by one or more identical or different heteroatoms selected from O, S, N and P,
R² is a divalent hydrocarbon radical having 1 to 200 carbon atoms optionally interrupted by one or more groups of the formulae —C(O)—, —C(O)O—, —C(O)NR¹, —NR¹—, —N⁺HR¹—, —O—, —S— and which is optionally substituted by F, Cl or Br,
R³ has the definition of R¹, or is a radical of the formulae —C(O)R¹ or —Si(R¹)₃,
A is a radical of the formula III
—R⁴(B)_{z} (III),
where
R⁴ is a divalent, trivalent or tetravalent hydrocarbon radical having 3 to 200 carbon atoms per radical, optionally interrupted by one or more groups of the formulae —C(O)—, —C(O)O—, —C(O)NR⁵, —NR⁵—, —N⁺HR⁵—, —N⁺R⁵R⁵—, —O—, —S—, —(HO)P(O)— or —(NaO)P(O)— and which is optionally substituted by F, Cl or Br, where
R⁵ is a hydrogen atom or a hydrocarbon radical having 1 to 200 carbon atoms per radical, optionally interrupted by one or more groups of the formulae —C(O)—, —C(O)O—, —C(O)NR⁵—, —NR⁵—, —N⁺HR⁵—, —N⁺R⁵R⁵—, —O— or —S— and which is optionally substituted by F, Cl or Br,
B has the definition of R⁵ or is a radical —COO⁻, —SO₃—, —OPO₃H_{y}—, —N⁺R⁵R⁵R⁵, —P⁺R⁵R⁵R⁵, —NR⁵R⁵, —OH, —SH, F, Cl, Br, —C(O)H, —COOH, —SO₃H, —C₆H₄—OH, —CₘF₂ₘ₊₁, 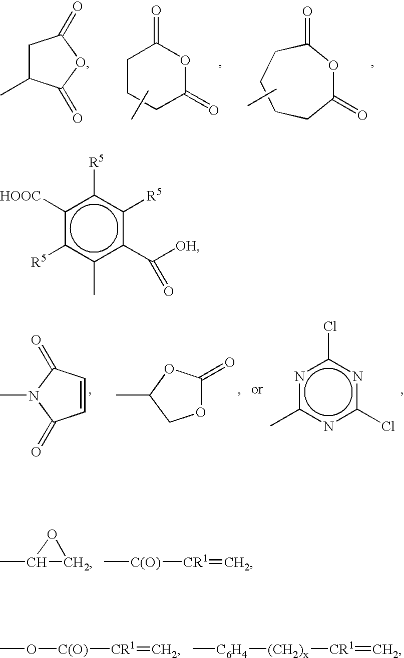
x is an integer of 1-20,
y is 0 or 1,
z, depending on the valence of R⁴, is 1, 2 or 3,
h is 0 or 1,
m is an integer of 1-20,
a, b, and c are each 0, 1, 2 or 3, with the proviso that sum a+b+c≦3, and e, f and g are each an integer of 0-200, with the proviso that the sum e+f+g>1, with the proviso that there is at least one radical A per molecule and that there is at least one radical X per molecule which is a radical —OR¹ where R¹ is a hydrogen atom,
wherein siloxanes (2) comprise units of the formula
$${{R}_{b} ( {OR}^{1} )}_{d} {SiO}_{\frac{4 - ( b + d )}{2}} \qquad ( VI )$$
where R, R¹, and b are as defined above and d is 0 or 1, with the proviso that the sum b+d≦3 and there is at least one radical R¹ per molecule which is a hydrogen atom, and
wherein silanes (3) are of the formula
WRₚSi(OR⁷)₃₋ₚ (VII)
or hydrolysis products thereof, wherein
W is a monovalent radical of the formula —CR⁶₂—Y,
R is as defined above,
R⁶ is a hydrogen atom or an alkyl radical having 1 to 4 carbon atoms,
Y is a monofunctional radical selected from the group consisting of halogens, monosubstituted atoms O and S, and substituted atoms N and P,
R⁷ is an alkyl radical having 1 to 8 carbon atoms per radical, and
p is 0, 1 or 2,
in the presence of at least one dispersion medium (4) and one or more emulsifiers (5), with the proviso that no metal-containing catalysts are used, and that siloxanes (1) and/or (2) and silanes (3) are present in type and quantity such as to give organopolysiloxanes which are crosslinked and insoluble in toluene.

2. The process of claim 1, wherein R₆ is hydrogen.

3. The process of claim 1, wherein p is 0 or 1.

4. The process of claim 1, wherein the dispersion medium (4) comprises water.

5. The process of claim 1, wherein radical A is a radical selected from the group consisting of
—(CH₂)₃—NH₂,
—(CH₂)₃—NH—CH₃,
—(CH₂)₃—NH—C₆H₁₁, and
—(CH₂)₃—NH—(CH₂)₂—NH₂.

6. The process of claim 1, wherein radical W is a radical of the formula —CH₂NHR⁸, —CH₂NR⁸₂ or —CH₂—NR⁹, in which R⁸ is a monovalent hydrocarbon radical having 1 to 18 carbon atoms, optionally containing one or more N or O atoms, and R⁹ is a divalent hydrocarbon radical having 3 to 12 carbon atoms, optionally containing one or more N or O atoms.

7. The process of claim 1, wherein at least one siloxane (1) is present and is of the formula
(R¹O)R₂SiO(SiR₂O)ᵣ(SiRAO)ₛSiR₂(OR¹) (IX)
where
s is an integer from 1 to 30, and
r is 0 or an integer from 1 to 1000,
with the proviso that 50% to 100% of all radicals R¹ are hydrogen atoms.

8. The process of claim 1, wherein at least one siloxane (2) is present and is of the formula
(R¹O)R₂SiO(SiR₂O)ₜSiR₂(OR¹) (X)
where
t is an integer from 1 to 1000,
with the proviso that 50% to 100% of all radicals R¹ are hydrogen atoms.

9. The process of claim 1, wherein silanes (3) comprise at least one trialkoxysilane where p is 0.

10. The process of claim 1, wherein silane (3) is used in amounts such that there are 0.6 to 5 equivalents of —OR⁷ per equivalent of —OR¹ in siloxane (1) and/or (2), R¹ being a hydrogen atom.

11. A dispersion comprising crosslinked organopolysiloxanes containing units of the formula
$${A}_{a} {R}_{b} {{W}_{n} ( {OR}^{1} )}_{d} {SiO}_{\frac{4 - ( a + b + d + n )}{2}} \qquad ( VIII )$$
and prepared by the process of claim 1,
where A, R, R¹, W, a, b, and d are as defined in claim 1,
n is 0 or 1,
with the proviso that the sum a+b+d+n≦3, a and n are not simultaneously 1 in the same siloxane unit, and that on average there is at least one radical W per molecule, at least one dispersion medium (4), at least one emulsifier (5), with the proviso that there are no metal-containing catalysts present and that the organopolysiloxanes are crosslinked and insoluble in toluene.

12. The dispersion of claim 11, wherein the dispersion medium (4) comprises water.

13. The dispersion of claim 11, wherein radical A is a radical selected from the group consisting of
—(CH₂)₃—NH₂,
—(CH₂)₃—NH—CH₃,
—(CH₂)₃—NH—C₆H₁₁, and
—(CH₂)₃—NH—(CH₂)₂—NH₂.

14. The dispersion of claim 11, wherein radical W is a radical of the formula —CH₂NHR⁸, —CH₂NR⁸₂ or —CH₂—NR⁹, in which R⁸ is a monovalent hydrocarbon radical having 1 to 18 carbon atoms, optionally containing one or more N or O atoms, and R⁹ is a divalent hydrocarbon radical having 3 to 12 carbon atoms, optionally containing one or more N or O atoms.

15. A shaped body produced by removing the dispersion medium (4) from a dispersion of claim 11.

16. The shaped body of claim 15, wherein the dispersion medium (4) is water, and wherein the dispersion is dried at a temperature of 5 to 150° C.

17. The shaped body as claimed in claim 16, which is a powder, a film or a coating.

18. A method of producing a coating, comprising applying a dispersion of claim 11 to a substrate and removing the dispersion medium (4).

19. A method of impregnating or infiltrating a substrate, comprising applying a dispersion of claim 11 to a substrate, impregnating or infiltrating the substrate or a surface thereof, and removing the dispersion medium (4).
